(19) United States
(12) Patent Application Publication
(10) Pub. No.: US 2023/0327572 A1
(43) Pub. Date: Oct. 12, 2023

(54) DEVICE AND METHOD FOR OPERATING A THREE-LEVEL OR MULTI-LEVEL CONVERTER

(71) Applicant: KEBA INDUSTRIAL AUTOMATION GERMANY GMBH, Lahnau (DE)

(72) Inventor: Johannes Visosky, Weimar (DE)

(21) Appl. No.: 18/023,079

(22) PCT Filed: Aug. 27, 2021
(86) PCT No.: PCT/EP2021/073726

§ 371 Date: Feb. 24, 2023

(30) Foreign Application Priority Data
Aug. 27, 2020 (DE) 102020122458.3

(51) Int. Cl. H02M 5/458

(52) U.S. Cl. CPC H02M 5/4585

(57) ABSTRACT

A device for balancing at least one intermediate potential of a DC intermediate circuit for operating a three-level or multi-level inverter has a half bridge with at least two electronic switches connected between two base potential rails of the DC intermediate circuit and at least one intermediate potential rail. A PWM switch generator is configured to operate the two switches in a variable duty cycle such that a desired intermediate potential, in particular a symmetrical intermediate potential, of the intermediate potential rail is settable. The half bridge is connected via a smoothing choke to the intermediate potential rail, and the smoothing choke is a coil side of an isolating transformer for operating a DC power pack. The DC power pack provides an internal voltage supply for operating the control electronics of the three-level or multi-level inverter, in particular a fan for cooling. An operating method is also provided.

### CROSS-REFERENCE TO RELATED APPLICATIONS

This application is the U.S. National Stage of PCT/EP2021/073726 filed on Aug. 27, 2021, which claims priority to German Patent Application 102020122458.3 filed on Aug. 27, 2020, the entire content of both are incorporated herein by reference in their entirety.

### FIELD OF THE INVENTION

The invention relates to a device for balancing at least one intermediate potential of a DC intermediate circuit, to operate a three-level or multi-level inverter, with provision of an internal voltage supply.

The invention furthermore relates to a method for operating a device to balance an intermediate potential of at least one intermediate potential rail of a DC intermediate circuit with two base potential rails, to operate a three-level or multi-level inverter in which an internal voltage supply is provided.

### BACKGROUND OF THE INVENTION

Various measures for balancing a DC intermediate circuit voltage are known from the prior art for operating an inverter used as a two-level, three-level or multi-level inverter to supply a motor or consumer or for grid feed operation. As a rule, for a two-level inverter electrolytic capacitors are connected in series in the DC intermediate circuit, since no electrolytic capacitors for smoothing are available on the market for a usually high intermediate circuit voltage of 500 V to 900 V. In the case of a three-level inverter, it is generally required for functional reasons to connect capacitors in series in the intermediate circuit, these capacitors having a center tap of an intermediate potential as the neutral point. Since a power unit of the three-level inverter is connected to a neutral point of the capacitors, half of an intermediate circuit voltage available at the neutral point plays an important role for the three-level inverter. The aim here is to select the DC voltage potentials of the intermediate circuit rails symmetrical to the neutral point potential.

For internal operation of the inverter, it is necessary to provide a supply voltage that keeps the microcontroller's control electronics in operation to generate control voltage pulses for the semiconductor power switches. In the case of air cooled inverters with high output, high power is needed particularly for the fans. For operation, a switch power pack is used as a rule, which taps energy from the DC intermediate circuit with a normal voltage level of 500 V to 900 V and converts it into one or more graduated low DC voltages. These low voltages supply the internal control electronics with a supply voltage and can operate a fan blower operated with voltages of up to 48 V DC, and need as a rule a powerful and separate isolating transformer in order to achieve a galvanic isolation from the power unit. The isolating transformer must here reserve sufficient power to operate a cooling unit such as, for example, a fan or a compressor cooling unit. Separate power packs of this type increase the number of components, need additional installation space, increase the manufacturing costs and increase the susceptibility to errors. Due to the relatively high DC intermediate circuit voltage, heavy expenditure of circuitry is necessary to provide low DC operating voltages.

EP 1 315 227 A1 shows a device for implementing a method to balance a three-level direct-voltage intermediate circuit. The device has two capacitors, the two capacitors being connected in series. A current converter circuit is connected to a connection port at which an intermediate circuit voltage of 0 V is provided. No indication is given that a DC operating voltage is provided for the internal voltage supply.

A method for reducing voltage oscillations of a three-level intermediate circuit of an inverter is known from EP 0 534 242 B1. On a single-phase side, first and a second three-level four-quadrant converters (H-bridge) are provided, which are each connected on the input side to the three-level intermediate circuit and which each generate by means of two basic frequency cycle patterns a single-phase output voltage with predetermined basic frequency. The generation of an internal voltage supply to the control electronics is not discussed in this connection.

U.S. Pat. No. 5,621,628 A discloses a balancing circuit designed as a voltage-guided and/or as a current-guided balancing circuit connected parallel thereto. The two control mechanisms are combinable in one parallel circuit. The balancing circuit adjusts only DC drift but also ripple voltages at an intermediate circuit center point. Much reactive power and expensive power electronics are needed to achieve this. This document too is silent about an efficient provision of an internal voltage supply.

A disadvantage of the prior art is that the capacitors have different leakage currents. A uniform voltage division therefore cannot be assured. To reduce a non-uniform voltage division, parallel-connected balancing resistors are usually employed, wherein a crosscurrent flowing through the balancing resistors should be greater than an expected leakage current difference. However, these crosscurrents cause considerable balancing losses in inverters with high output and lead to undesirably high interior temperatures. Since there are generally undesirable imbalances present in the three-level inverter hardware, this leads to a parasitic direct current flowing in the neutral point. The direct current is as a rule so large that passive balancing of the intermediate circuit is no longer possible using the balancing resistors. If balancing of the intermediate circuit is assured in the operating inverters by the inverter software, in that the latter delays actuation of the inverter switches such that the imbalance of the intermediate circuit is counteracted by a suitable asymmetrical withdrawal of energy from the intermediate circuit by the inverter, this results in the problem that a minimum effective power must be drawn from the intermediate circuit for balancing. This means that balancing is difficult to perform in those operating states in which only reactive power flows between the connected inverter and the grid or motor or consumer connected thereto. In addition, it is necessary that directions of motor currents or grid currents must be known for successful balancing. A current sensor used for current measurement has, as a rule, an offset in a measurement signal. This can lead, in the case of low currents, to imbalances of the intermediate circuit being amplified in the event of balancing by the inverter software, and to the neutral point drifting away. Due to the offset of the current sensor being as a rule different for all phases, this problem is almost insoluble.

These problems are particularly disadvantageous in the three-level inverters used for supplying a stand-alone microgrid, for example in combined heat and power units for single-family houses. A complete no-load situation can occur here, if for example all consumers are switched off during the night. Feeding of reactive current into the stand-alone microgrid is impossible, since a voltage has to be preset by the three-level inverter.

Finally, an additional and powerful DC low voltage power pack must be provided for the internal voltage supply, which is impaired by the high heat buildup and which increases the overall costs. This power pack reduces as a rule the very high intermediate circuit voltage to a DC operating voltage of, for example, 24 V in order to supply the control electronics for operating the internal power semiconductors or a fan for cooling.

In particular, a dependable and powerful DC operating voltage supply is necessary here for supplying fans of air cooled inverters with high rated output, since the fans can have a power input of over 100 W. Fans of this type for high output are usually operated with 24 V or 48 V. Further DC voltage levels can be derived from the DC basic voltage, for example by DC/DC converters, allowing for example the operating voltage for the control electronics to be derived by means of a step-down converter.

Proceeding from the above prior art, the object of the invention is to propose a device and an operating method for balancing at least one intermediate potential of a DC intermediate circuit for operating a three-level or multi-level inverter, whereby a supply voltage to the control electronics and to the cooling unit is providable inexpensively.

This object is achieved by a device and a method for balancing at least one intermediate potential of a DC intermediate circuit for operating a three-level or multi-level inverter with provision of an internal voltage supply, as disclosed herein. Advantageous embodiments of the invention are also disclosed herein.

### SUMMARY OF THE INVENTION

The invention relates to a device to balance at least one intermediate potential of a DC intermediate circuit for operating a three-level or multi-level inverter, wherein a half bridge with at least two electronic switches is connected between two base potential rails of the DC intermediate circuit and at least one intermediate potential rail. A PWM switch generator is configured to operate the two switches in a variable duty cycle such that a desired intermediate potential, in particular a symmetrical intermediate potential, of the intermediate potential rail is settable relative to the potentials of the base potential rails.

In accordance with the invention, it is proposed that the half bridge is connected via a smoothing choke to the intermediate potential rail, and that the smoothing choke is the primary winding of an isolating transformer for operating a DC power pack.

The isolating transformer has at least one secondary winding, wherein the primary winding for example can be designed as a smoothing choke, i.e. as a storage choke with air gap with at least one wound-on auxiliary winding as a secondary winding. Advantageously, the auxiliary winding can provide the one or more AC supply voltages, of different levels and electrically isolated, of the DC power pack, wherein advantageously several galvanically isolated secondary windings can be provided for different AC voltage levels. This allows several electrically isolated AC output voltages to be provided for different applications, e.g. fan operation, electronic voltage supply etc.

In other words, a device is proposed for balancing a DC intermediate potential. In the device, a half bridge consisting of at least two electronic switches, preferably MOSFET or IGBT power switches, is arranged at the DC intermediate circuit, wherein MOSFET switches or IGBT switches can be used as electronic switches. It is also possible to use more than two electronic switches, for example two times two switches connected in parallel, in the half bridge. The half bridge is connected via a smoothing choke to an intermediate potential rail at a neutral point or intermediate circuit center point, wherein at the neutral point the potential is zero, or the arithmetical mean of the intermediate circuit potential difference. The device further comprises a PWM (pulse width modulation) switch generator. The fact that different pulse width modulated signals can be generated by the PWM switch generator allows the two switches to be operated in a variable duty cycle such that a desired intermediate potential or a symmetrical intermediate potential of the intermediate potential rail is set. Advantageously, the PWM switch generator provides a dead time, which if required can be variably settable, and in which the switches are open. This prevents a short-circuit and takes account of at least one differing switching time of the semiconductor power transistors. Advantageously, the smoothing choke can be designed as a choke with air gap for energy storage, also referred to as a storage choke. A direct current with superimposed switching-frequent ripple current flows in the smoothing choke.

Since no DC voltage can drop over the smoothing choke, the result is a uniform voltage division over the two smoothing capacitors present as a rule which connect the intermediate potential rail to the base potential rails. In the event of an imbalance, a direct current flows via the smoothing choke until symmetry is restored.

In accordance with the invention, the smoothing choke is designed as the primary winding of an isolating transformer provided for operation of a DC power pack, in order to provide in particular an internal voltage supply to the three-level or multi-level inverter, and to operate in particular a fan or an air conditioning unit for cooling or air conditioning. To do so, a rectifier unit and where necessary backup capacitors can be connected downstream of the secondary winding of the isolating transformer, in order to provide a fixed or variable DC supply voltage, in particular a multi-stage DC supply voltage for supplying the control electronics of the inverter. The smoothing choke thus has two tasks: on the one hand inductive coupling of the intermediate circuit to the actively operated half bridge for setting the intermediate potential, and on the other one hand the formation of an isolating transformer for decoupling a voltage supply of the internal electronics and of the fan. Energy for supplying voltage to the electronics and for fan operation or for air conditioning can be decoupled from the smoothing choke as the primary side, via the one or more auxiliary windings as the secondary side of the isolating transformer. This allows the use of an additional transformer to be dispensed with. Thanks to a relatively inexpensive rectifier stage with backup capacitors, a stable and strong operating voltage can be generated with low component expenditure.

It is advantageous when the device in accordance with the invention permits active intermediate circuit balancing and operating voltage provision. As a result, problems during balancing due to inverter software measures can be completely avoided. Besides that, it is possible to operate the three-level or multi-level inverters on a load-free grid without restrictions and inexpensively for feeding stand-alone microgrids. Balancing losses can be largely avoided in the case of high outputs. Advantageously, a high-resistance passive balancing can be additionally provided if required in order to bridge the time until the startup of active balancing.

In accordance with the invention, therefore, the smoothing choke is designed as a primary winding of an isolating transformer, such that a variable voltage is induced on one or more secondary windings of the isolating transformer. The secondary voltage or a plurality of secondary voltages are provided for AC supply to a DC power pack. The DC power pack can for example be designed as a rectifier with charging capacitor, full-wave bridge rectifier or voltage doubler according to Greinacher, and can preferably make available several DC voltage potentials for supplying, for example, a fan with 48V and the electronics with 5 V or 3.3 V. No substantial DC voltage can drop over the smoothing choke or isolating transformer. In the case of an intermediate circuit imbalance, a direct current thus flows through the choke or isolating transformer to compensate for the imbalance. The balancing output is fed back from the half bridge into the intermediate circuit, hence there is almost no power loss. An additional power pack can thus be dispensed with.

The neutral point or the intermediate circuit center point of the intermediate potential is thus connected to an output of the half bridge via the smoothing choke as the primary side of an isolating transformer. No substantial DC voltage can drop over the primary side of the isolating transformer. A potential-free and galvanically isolated supply voltage is made available at at least one secondary winding by means of the isolating transformer. Furthermore, it is possible to provide active balancing of the intermediate circuit inexpensively and almost loss-free.

As a rule, the DC power pack comprises at least one bridge rectifier and capacitors serving for voltage stabilization. In an advantageous development, the DC power pack can comprise a DC converter for controlled provision of one or more DC voltage levels, with which converter a low or high DC voltage may be provided at an output side of the DC power pack. If required, the DC power pack can be designed either as a step-down converter or as a step-up converter, the use of step-down converters being preferable. The downstream step-down converter stabilizes the electrically isolated DC supply voltage to the inverter, in particular to a fan for cooling or to an air conditioning unit. It is advantageously achieved with the DC power pack that the supply voltages generated on the secondary side of the isolating transformer by means of one or more electrically isolated secondary windings can be stabilized and adapted to one required DC voltage potential or to several required DC voltage potentials. The DC voltage potential(s) is/are however dependent on the level of the intermediate circuit voltage, which can fluctuate within certain limits. To compensate for a fluctuating intermediate circuit voltage, DC/DC converters, in particular step-down converters, can be advantageously used.

In an advantageous development, the DC power pack can provide a voltage in the range from 3.3 V to 48 V DC, as a rule 24 V or 48 V, wherein lower voltage levels can be derived from a higher DC voltage. In particular, several voltage levels, e.g. 3.3 V, 5 V, 15V and 24 V, and also 48 V, including opposite-pole voltage levels, e.g. +/−15 V can be provided for operation of a microcontroller as the control voltage, and also of a fan blower.

Furthermore, the secondary side of the isolating transformer can advantageously comprise several secondary windings which provide identical or differing transformation ratios with the primary winding, to provide identically or differently high and galvanically isolated AC output voltages. Different DC voltages can thus be made available on the secondary side, wherein an associated DC voltage can be derived from each of the differing AC voltages on the secondary side and in a further optional step one or more additional DC voltages can each be generated by DC/DC converters from one or more of these DC voltages.

In an advantageous development, the DC power pack can comprise a Greinacher voltage doubler circuit. A Greinacher voltage doubler comprises, connected to the isolating transformer, two capacitors and two diodes and permits, with purely passive components, a doubling of the level of DC voltage applying at the output when compared to the amplitude of the AC voltage applying at the input, and which is output by the isolating transformer on the secondary side. This allows the output DC voltage to be provided regardless of the duty cycle of the half bridge. A Greinacher voltage doubler rectifier circuit can be connected downstream of the intermediate circuit voltage reduced with the transformation ratio of the isolating transformer, and permits doubling of a rectified DC output voltage of the isolating transformer. A further voltage stabilization is advantageously possible by an inexpensive downstream step-down converter, and can be expedient in particular in those applications in which there is variability of the intermediate circuit voltage, such that in these cases a variability of the DC output voltage results from the dependence of the DC output voltage on the intermediate circuit voltage. A Greinacher voltage doubler thus permits an inexpensive and robust provision of a supply voltage in comparison with an electrically isolated high-voltage power pack operated directly at the intermediate circuit.

Advantageously, the intermediate potential rail can be connected to the two base potential rails via smoothing capacitors. The smoothing capacitors can reduce the ripple and also its fluctuations to a level such that the DC voltage can be used with the least possible residual ripple. One smoothing capacitor can be as close as possible to a rectifier circuit and another as close as possible to the inverter. Since no DC voltage can drop over the smoothing choke, this automatically results in a uniform voltage division over the smoothing capacitors. A ground reference of the control electronics can be advantageously defined at the connection point of the series-connected smoothing capacitors.

In a further advantageous development, the PWM switch generator can be configured to set a predefinable duty cycle, in particular a 50% duty cycle of the two switches. In other words, the half bridge can be operated with a fixed duty cycle of, for example, 50%. With a 50% duty cycle, half the intermediate circuit voltage can drop over the first and second switches on average in each case. However, it can in practice occur quite usually, and also be necessary, that two switches are switched off for a short period, and hence a dead time is provided in the switching behavior. The dead time, more precisely a switch-on time lag for the switches, is added downstream of the generation of the PWM signal. This is identical for both switches, and the result is a control signal for the switches with a duty cycle slightly diverging from 50%. The consequences of this slight divergence are however negligible in the practical application and are therefore ignored in the following. The following therefore continues, for the sake of simplicity, to assume a duty cycle of 50%. In the case of three-level inverters, a sinusoidal alternating current is fed into the neutral point NP during operation. The current has three times the rotation frequency of the motor, and three times the frequency of the fed supply grid. This current recharges the intermediate circuit capacitors slightly, such that at the neutral point a sinusoidal AC voltage is obtained which has a low amplitude in relation to the intermediate circuit voltage. This AC voltage would, in the case of a half bridge operating with a 50% duty cycle, lead to an unnecessarily high balancing current through the choke and put unnecessary stain on the components. A fixed duty cycle, in particular a 50% duty cycle, is therefore only expedient for low inverter outputs of less than 10 kW. In addition, this balancing current can, in the case of three-level inverters with low output, advantageously be reduced to tolerable values by a damping resistor described in the following without impairing the balancing effect. As a result, an unnecessarily high current load on the half bridge and the smoothing choke can be avoided. A “soft balancing behavior” of this type can be achieved in a fixed duty cycle, e.g. a 50% duty cycle, by a correspondingly high rating for the impedance in the series connection of the smoothing choke and of the damping resistor. If an AC voltage is applied at the neutral point, the resulting parasitic alternating current through the smoothing choke becomes so low that over-dimensioning of the components is unnecessary, in particular when the RMS value of the alternating current remains less than 10% of the DC current.

Since an electrically isolated supply voltage derived from the intermediate circuit voltage is needed as a rule for the inverter, for example for supplying current to a fan, an electrically isolated voltage can be very simply provided by an auxiliary winding on the smoothing choke on the basis of the active intermediate potential balancing, leading to a significant saving on hardware. If an at least approximately 50% duty cycle is set, the voltage at the auxiliary winding is a square wave voltage, wherein the duty cycle in the inverter subjected to load fluctuates only slightly due to the alternating current feed into the neutral point.

In a further advantageous development, the smoothing choke can be connected in series to a damping resistor. In the case of an imbalance, a compensating current can flow via the smoothing choke until balance can be restored. If the compensating current is not too high, an ohmic winding resistance of the smoothing choke can enlarged by an additional series resistor. This series resistor can advantageously act as a damping resistor for vibration damping, wherein losses in the damping resistor are very low. By connecting the damping resistor to a sufficiently high inductance, a “soft” balancing behavior can be achieved.

In a further advantageous development, two damping resistors can be connected in series in the half bridge, wherein their connection point, i.e. the center tap of the series connection of the damping resistors, can be connected to the intermediate potential rail by the smoothing choke.

In the case of inverters with high output, the half bridge cannot be operated with a constant 50% duty cycle, since the losses in the damping resistor might become too high due to the considerably higher balancing currents. A damping resistor should be dispensed with here, and the duty cycle of the half bridge adaptively updated/readjusted to the AC voltage at the neutral point such that no balancing current with triple rotation frequency or triple grid frequency can flow. The duty cycles of T1 and T2 can be different here. In particular, they can be set such that their sum is one when the dead time described above is omitted. A shunt resistor is preferably provided for current measurement. This enables an unnecessarily high current load on the half bridge and on the choke to be avoided. Only a direct current with a superimposed switching-frequent ripple current flows in the choke. To that extent, adaptive control of the duty cycle is advantageous.

In a further advantageous development, a current controller can be comprised which sets the duty cycle based on the level of a current through the smoothing choke which can for example be tapped by a voltage measurement at the damping resistor or at a shunt resistor. For example, a current difference of a current between the switch half bridge and the bridge of the smoothing capacitor in the intermediate potential rail can be determined by the smoothing choke. A neutral point input current of the three-level or multi-level inverter can also be measured. A current difference of choke current and neutral point input current can be adjusted by means of the duty cycle, in particular adjusted to zero, such that a parasitic compensating current between the switch half bridge and the capacitor half bridge is minimizable, and the choke current is matchable to the neutral point input current. The current controller can be designed such that it operates particularly fast. The set value of the current controller should advantageously be limited by a limit value to prevent any overloading of the components. This embodiment can also be advantageously used when no isolating transformer is formed by the smoothing choke for operating the DC power pack.

In a further advantageous development, a voltage controller can be comprised, which can, on the basis of a voltage difference between the base potential rails and the intermediate potential rail, adjust the duty cycle of at least one PWM signal of the PWM switch generator with regard to a desired intermediate potential, wherein it is preferably adjustable to a symmetrical intermediate potential of the intermediate potential rail. The voltage controller can be designed such that it operates particularly slowly. The voltage controller can be designed so slow that an AC voltage prevailing at the neutral point during operation is largely ignored. In the case of an imbalance, the voltage controller requests, by adjusting of the duty cycle of at least one PWM signal, in particular of both PWM signals of the PWM switch generator, an averaged direct current between half bridge and intermediate circuit, which after a time can completely eliminate the imbalance. It is advantageous when the voltage controller can influence the duty cycle of the PWM switch generator in line with the voltage difference between the base potential rails and the intermediate potential rail, in order to adjust the intermediate potential at the neutral point as required and in particular to set a voltage difference of the potential differences +ZK to NP and NP to −ZK to zero. This embodiment can also be advantageously used when no isolating transformer is formed by the smoothing choke for operating the DC power pack.

In a further advantageous development, the voltage controller and the current controller can be connected one behind the other as a cascade controller, wherein the current controller has in particular a faster control behavior than the voltage controller. In this case the current controller preferably considers a current flow through the smoothing choke, between the switch half bridge and a smoothing capacitor half bridge, as the input value. Cascade control entails the cascading of several controllers, wherein the associated control circuits are nested in one another. In a preferred embodiment, the cascade controller is provided in the form of the voltage controller with subordinate current controller, wherein the control variable of the voltage controller provides the input variable of the current controller. It is advantageous when a ground reference of an operating microcontroller is arranged at the neutral point. To do so, an actual current value is possible inexpensively with a shunt current measurement at the “electronic ground”. Furthermore, a voltage measurement can be performed inexpensively by means of a voltage divider. The voltage divider can consist of at least two passive electrical resistors, at which the potential differences drop between +ZK (positive intermediate circuit potential) and NP (intermediate potential), and between NP (intermediate potential) and −ZK (negative intermediate circuit potential) respectively. In the case of an imbalance, the superimposed voltage controller requests from the current controller a direct current which in turn influences the duty cycle of the half bridge power switches such that after a time the imbalance can be completely eliminated. A current setpoint value for the current controller can be limited to prevent any overloading of the components. Furthermore, an overcurrent shutoff can be provided for the event of a fault. Since both the controlled system of the current controller and the controlled system of the voltage controller advantageously have an integral behavior, the two controllers can be designed for example as PT1 controllers. The two cascaded controllers and the PWM switch generator can be designed by means of software measures. This embodiment can also be advantageously used when no isolating transformer is formed by the smoothing choke for operating the DC power pack.

In the case of larger inverters, for example with an output of 100 kW or higher, a variable duty cycle, in particular controlled by means of the previously mentioned cascade control, can be advantageously used. The duty cycle of the half bridge can be updated to the AC voltage at the neutral point or be defined such that no balancing current with triple rotation frequency or triple grid frequency can flow. In this way, it is possible with a high inverter output to achieve a soft balancing behavior for example by a fast current controller and a slow voltage controller in a controller cascade.

In addition, a method is proposed in a subordinate aspect of the invention for operating a previously shown device to balance an intermediate potential of at least one intermediate potential rail of a DC intermediate circuit in relation to two base potential rails for operating a three-level or multi-level inverter. To do so, a half bridge with at least two electric switches is provided, of which the center tap connects the intermediate potential rail to the two base potential rails via a smoothing choke and the switches. A desired intermediate potential, in particular a symmetrical intermediate potential, is set by setting a variable duty cycle of the electric switches. Via the smoothing choke, designed as the primary winding of an isolating transformer, an output voltage for operating a DC power pack, in particular for a fan or air conditioning mode, is provided for cooling.

In an advantageous development, the duty cycles can be set symmetrically, and in particular a 50% duty cycle can be set.

In a further advantageous development, at least one duty cycle can be set by means of voltage control by a voltage controller on the basis of a voltage difference between the intermediate potential and the two base potentials. This embodiment can also be advantageously used when no isolating transformer is formed by the smoothing choke in the previously shown device for operating the DC power pack.

In a further advantageous development, at least one duty cycle can be set by means of differential current control by a current controller on the basis of a current difference between the current through the smoothing choke connecting the half bridge to a smoothing capacitor half bridge of the intermediate potential rail and the neutral point input current of the three-level or multi-level inverter. This can also be advantageously used when no isolating transformer is formed by the smoothing choke in the previously shown device for operating the DC power pack.

A three-level inverter injects during operation an alternating current with triple grid frequency—in the case of motors with triple rotating field frequency—into the intermediate circuit center point (neutral point NP). This alternating current can cause a sinusoidal dynamic voltage imbalance (voltage ripple) at the neutral point, since the intermediate circuit capacitors are recharged with this current.

In the case of inverters of low output, the half bridge can be operated with a fixed duty cycle of 50%. A sinusoidal compensating current, unavoidable here, in the smoothing choke with triple grid frequency—in the case of motors with triple rotating field frequency—is as a rule limited to an acceptable amplitude by a damping resistor. A cascade control is not required.

In a further advantageous development, setting of at least one duty cycle can be performed by a cascade control of voltage control and current control, wherein current control on the basis of the choke current as the input variable has a faster control behavior than voltage control, and voltage control and current control preferably have a PT1 control behavior. This embodiment can also be advantageously used when no isolating transformer is formed by the smoothing choke in the previously shown device for operating the DC power pack.

To eliminate the aforementioned dynamic voltage imbalance, very expensive power electronics would be required that should supply an inversely phased current of the same amplitude as the current injected by the inverter. A dynamic voltage imbalance of a few volts is however unproblematic and it is not necessary to eliminate it. To permit it, the duty cycle of the half bridge can be adaptively updated such that no sinusoidal compensating current of the same frequency can flow through the smoothing choke. For that purpose, the duty cycle can advantageously be designed variable and can diverge slightly from 50%. Adaptive updating of the duty cycle can be performed by the current controller. The current controller receives from the superimposed slow voltage controller a current setpoint value not containing any AC component. The current controller is so fast in its control behavior that it can update the duty cycle fast enough to suppress the undesirable AC component through the smoothing choke. Hence no AC component with triple grid frequency—in the case of motors with triple rotating field frequency—can flow in the smoothing choke. The voltage controller can ignore the dynamic imbalance, as it is so slow that it cannot adjust the dynamic imbalance. By contrast, the voltage controller can adjust the static imbalance. Inexpensive power electronics can thus be achieved that only have to be rated for the DC component in the NP current, which is very low compared with the AC component.

An advantageous application of the invention is charging and/or discharging a vehicle traction battery: In this case, a vehicle is connected via an at least two-conductor cable to a charging station which has at least one intermediate circuit, with balancing in accordance with the invention, and at least one DC/DC converter arranged between the intermediate circuit and the at least two-conductor cable. The vehicle contains at least one traction battery from which it can draw energy to move it. The charging station can provide the vehicle via the at least two-conductor cable with a DC voltage or a direct current for the purpose of electrical energy storage in the vehicle traction battery. In an improved embodiment, the charging station can draw electrical energy from the traction battery via the at least two-conductor electric cable.

In an advantageous development, the energy drawn by the charging station from the traction battery can be fed at least partially into an electric energy supply grid connected to the charging station, allowing the charging station to be used bidirectionally for charging and discharging, to buffer preferably regenerative energy for grid backup.

### BRIEF DESCRIPTION OF THE DRAWINGS

Further advantages emerge from the following drawing description. The drawing shows examples of the invention. The drawing, the description and the claims contain many features in combination. The person skilled in the art will also consider the features individually, and combine them into useful further combinations.

In the figures:

FIG. 1 shows an inverter of the prior art;

FIG. 2 shows a further inverter of the prior art;

FIG. 3 shows a device to balance an intermediate potential of a DC intermediate circuit for operating a three-level inverter;

FIG. 4 shows a further device to balance an intermediate potential of a DC intermediate circuit for operating a three-level inverter;

FIG. 5 shows a first embodiment of a device in accordance with the invention;

FIG. 6 shows a second embodiment of a device in accordance with the invention;

FIG. 7 shows a third embodiment of a device in accordance with the invention;

FIG. 8 shows a fourth embodiment of a device in accordance with the invention; and

FIG. 9 shows a fifth embodiment of a device in accordance with the invention.

### DETAILED DESCRIPTION OF THE INVENTION

Identical elements are denoted with the same reference signs in the figures. The figures merely show examples and should not be understood as being limiting.

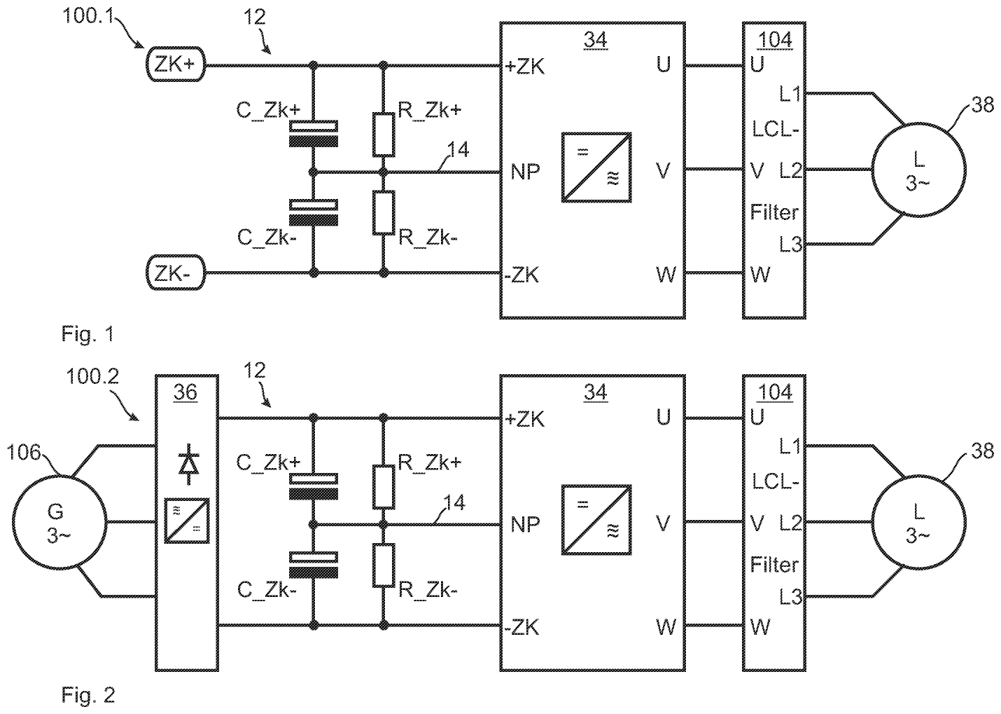

FIG. 1 and FIG. 2 show inverter circuits 100.1, 100.2 that are known from the prior art. The inverter circuits 100.1, 100.2 can be provided for supplying a three-phase consumer L 38 in FIG. 1 and in FIG. 2. A smoothing capacitor C_ZK+ and a smoothing capacitor C_ZK− are connected in series between two base potential rails ZK+, ZK− of a DC intermediate circuit 12, wherein an intermediate potential rail 14 is connected to its center tap to provide a neutral point NP. Since the smoothing capacitors C_ZK+, C_ZK− can have different leakage currents, a uniform voltage division cannot be assured. To remedy this problem, voltage divider resistors R_ZK+, R_ZK−, the sizes of which may also not be exactly identical, are connected in parallel. A three-level inverter 34 is connected to the smoothing capacitors C-ZK+, C-ZK− via the intermediate potential rail. A filter 104 for damping undesirable harmonics is provided between the three-level inverter 34 and the three-phase consumer L or three-phase grid G or three-phase motor M 38.

FIG. 2 furthermore shows in the inverter 100.2 a rectifier 36 arranged between a three-phase grid G 106 and the intermediate circuit 12.

The inverter configurations known from the prior art need a separate and powerful DC voltage supply to operate the control electronics, not shown, which provides switching pulses for operating the power semiconductor switches of the three-level or multi-level inverter 34 and for supplying an energy-intensive cooling system with a fan or a cooling unit. The cooling system regularly has high power inputs of 100 W and more, needing a powerful and dependable voltage supply.

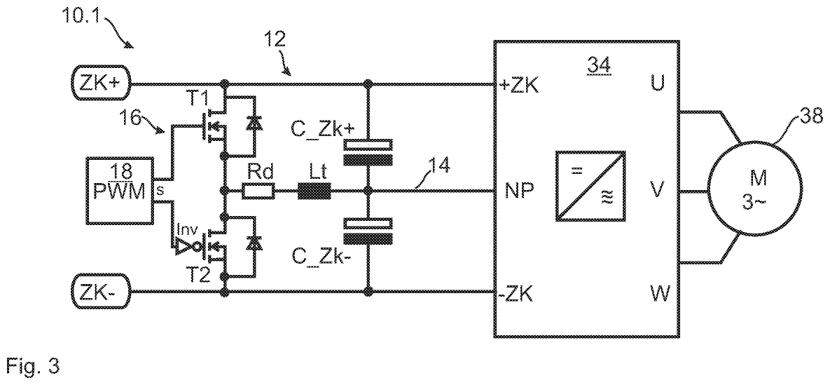

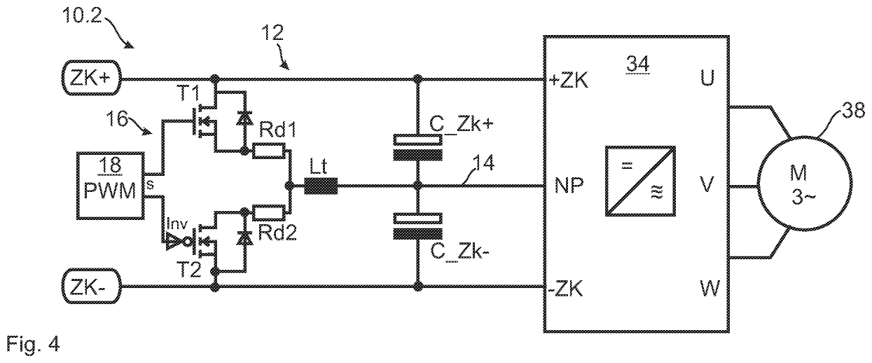

FIG. 3 and FIG. 4 first show devices for intermediate circuit potential balancing 10.1, 10.2, to operate a three-level inverter 34. The three-level inverter 34 is configured to supply current to a three-phase motor M 38. A half bridge 16 is connected between two base potential rails ZK+, ZK− of the DC intermediate circuit 12 and intermediate potential rail 14, wherein the half bridge 16 is provided with two electronic switches T1, T2. The two electronic switches T1, T2 can be designed as power transistors. In the devices 10.1, 10.2, a PWM switch generator 18 is provided in each case that operates the two switches T1, T2 in a variable duty cycle such that a desired intermediate potential, in particular a symmetrical intermediate potential, of the intermediate potential rail 14 is set. A predefinable duty cycle, preferably a 50% duty cycle of the two switches T1, T2, can be set with the PWM switch generator 18. An application-specific imbalance can also be statically compensated by a modification of the duty cycle. An inverter Inv is connected between the PWM switch generator 18 and the electronic switch T2. In practice, a dead time is usually provided, during which both switches are switched off in order to prevent a short-circuit of the bridge due to a switch-off time lag of the semiconductors. To that extent, the inverter has at least one dead time switchover time lag.

Furthermore, in FIG. 3 and FIG. 4 the intermediate potential rail 14 is connected to the two base potential rails ZK+, ZK− via smoothing capacitors C_ZK+, C_ZK− respectively.

In FIG. 3, the half bridge 16 is connected via a smoothing choke Lt and a damping resistor Rd to the intermediate potential rail 14, with the smoothing choke Lt and the damping resistor Rd being connected in series.

In FIG. 4, two damping resistors Rd1, Rd2 are connected in the half bridge 16. The intermediate potential rail 14 is connected via the smoothing choke Lt to a common connection point of the damping resistors Rd1, Rd2. The two damping resistors Rd1, Rd2 are as a rule of equal size.

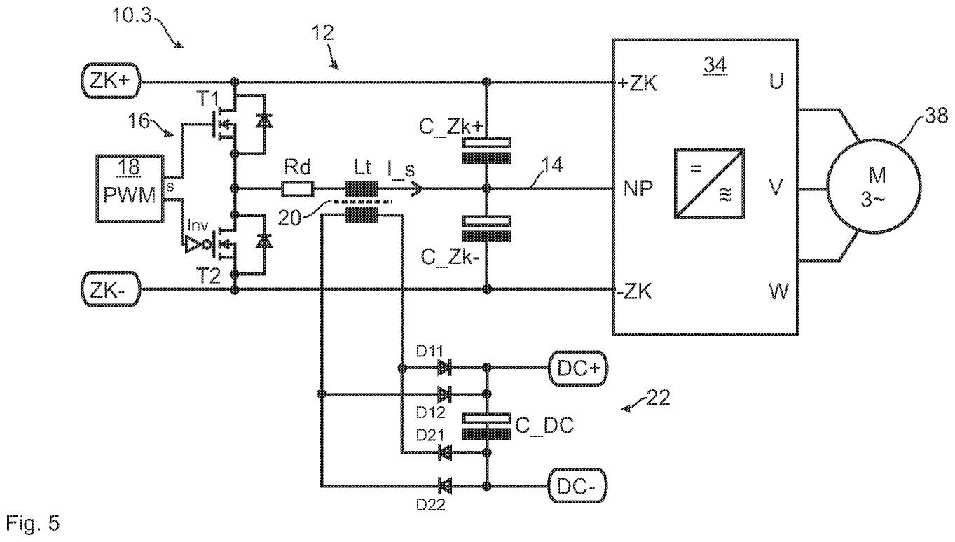

FIG. 5 shows a first embodiment of a device in accordance with the invention for intermediate circuit potential balancing 10.3, to operate a three-level inverter 34. This corresponds substantially to the device shown in FIG. 3, wherein the three-level inverter 34 supplies a three-phase motor M 38. The smoothing choke Lt is used as a primary winding of an isolating transformer 20 for operating a DC power pack 22. In the DC power pack 22, power pack diodes D11, D12 and power pack diodes D21, D22 are connected with the correct polarity between the buffer capacitor C_DC and the secondary side of the isolating transformer 20, and perform a conversion of the bridge DC voltage. Hence a stabilized DC low voltage for operating the control electronics of the inverter 34 can be provided, wherein a separate high-voltage power pack can be dispensed with.

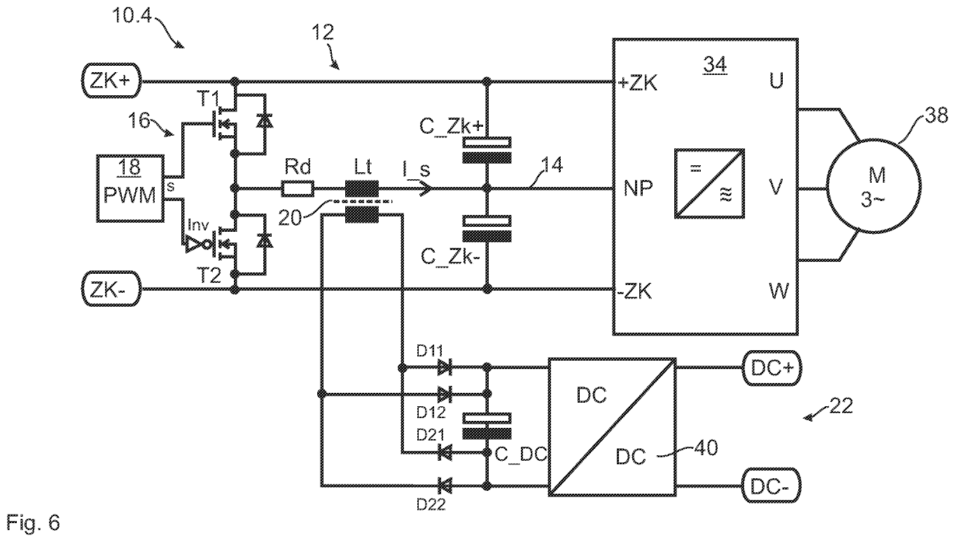

FIG. 6 shows in perspective a second embodiment of a device in accordance with the invention for intermediate circuit potential balancing 10.4, to operate a three-level inverter 34 for supplying current to a motor M 38. This is substantially identical to the design of the example according to FIG. 5. However, this example differs from the example shown in FIG. 5 in that the DC power pack 22 comprises a DC converter 40. The DC converter 40 can be designed as a step-down converter or step-up converter, enabling a supply voltage generated on the secondary side of the isolating transformer 20 to be stabilized. The supply voltage can thus be individually adapted to a voltage level of the DC power pack 22. In particular, one or more stabilized voltage levels, e.g. 3.3 V, 5 V and 24 V or 48 V, can be made available that can also be provided when the input voltage fluctuates and independently of the duty cycle of the switches T1, T2.

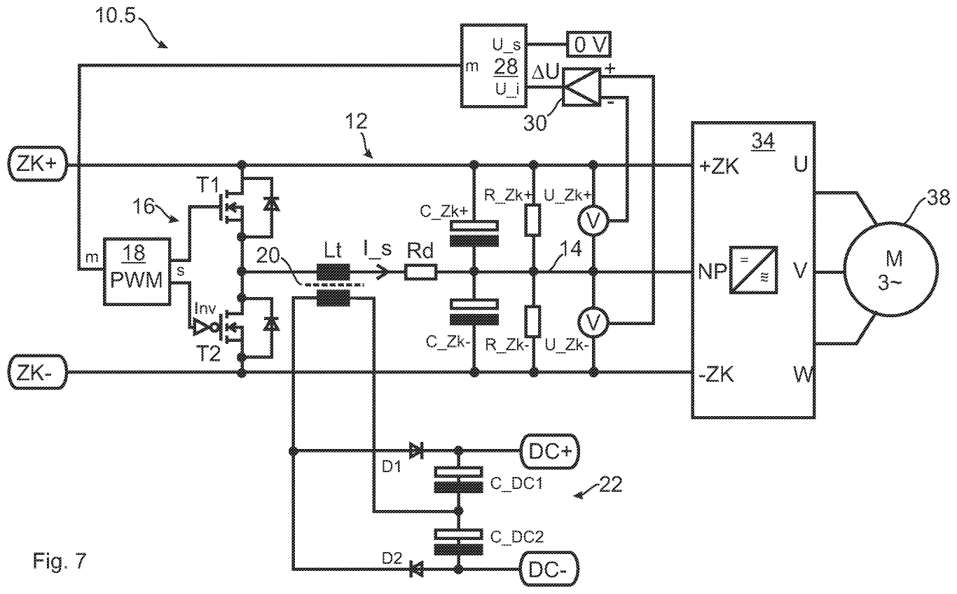

FIG. 7 shows a third embodiment of a device in accordance with the invention for intermediate circuit potential balancing 10.5, to operate a three-level inverter 34 that substantially matches the example of FIG. 5 or FIG. 6. This embodiment shows an adaptive, voltage-guided control of the duty cycle of the half bridge. To do so, voltage divider resistors R_ZK+, R_ZK− are connected in parallel behind the smoothing capacitors C_ZK+, C_ZK−, in order to ensure a uniform voltage division when the inverter and the balancing are switched off. For measuring the voltages of the voltage divider resistors R_ZK+, R_ZK−, two voltmeters U_ZK+, U_ZK− are provided which determine the voltages between the potential differences +ZK and NP, or NP and −ZK. The two voltmeters U_ZK+, U_ZK− are connected to a differential amplifier 30 in order to increase a potential difference between the intermediate potential and the base potentials ΔU, and to provide it as a differential voltage actual value for a voltage controller 28. The voltage controller 28 can adjust, on the basis of the potential difference between the base potential rails ZK+, ZK− and the intermediate potential rail 14, the duty cycle of the PWM switch generator 18 in respect of a desired intermediate potential, such that the potential difference is minimized or adjusted to zero. The DC power pack 22 is connected in the manner of a Greinacher voltage doubler with two diodes D1, D2 and two capacitors C_DC1 and C_DC2. The DC output voltage is doubled due to the Greinacher circuit topology, also referred to as a Delon circuit, relative to the AC amplitude of the secondary side of the isolating transformer, and can thus be set regardless of the duty cycle of the switches.

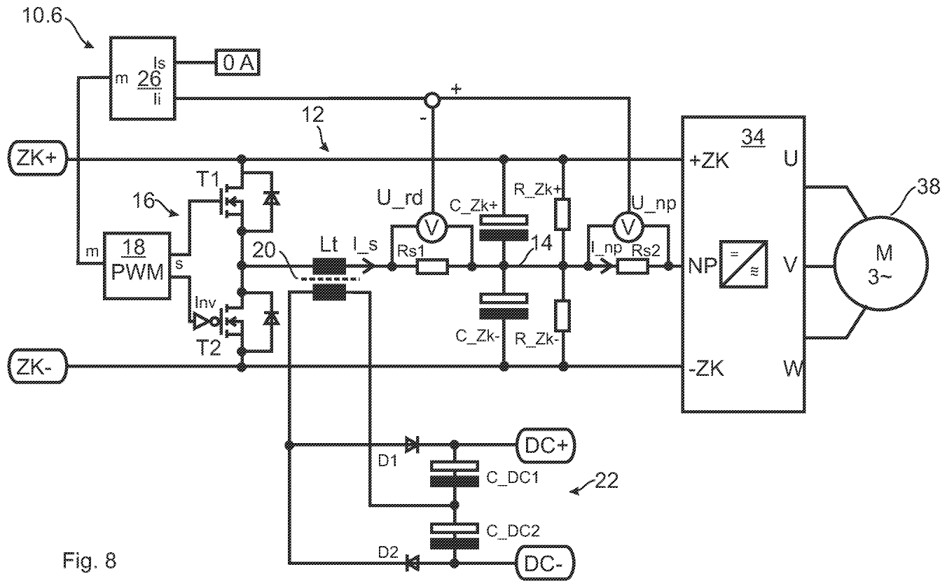

FIG. 8 shows a fourth embodiment of a device in accordance with the invention for intermediate circuit potential balancing 10.6, to operate a three-level inverter 34. This is substantially comparable with the design of the example according to FIG. 7 with a Greinacher voltage doubler in the DC power pack 22. However, this example differs from the example shown in FIG. 7 in that instead of the voltage controller 28 and the voltmeters U_ZK+, U_ZK−, a current controller 26 is provided with an input variable as the difference of a shunt resistor voltage measurement U_rd at the shunt resistor R_s1, i.e. of the choke current I_s, and a further shunt resistor voltage measurement U_np at the shunt resistor R_s2, i.e. of the neutral point input current I_np of the inverter 34. The current controller 26 adjusts the duty cycle on the basis of the difference of the compensating current I_s between half bridge 16 and bridge of the smoothing capacitors C_zk+/C_zk−, and of the neutral point input current I_np of the three-level inverter 34 in the intermediate potential rail 14. The shunt resistor Rs1 acts as the current measurement shunt of the compensating current I_s for measuring U_rd, and the shunt resistor Rs2 as the current measurement shunt R_s2 of the neutral point input current I_np for measuring U_np. The current controller 26 can adjust, on the basis of the differential current ΔI=I_np/I_s, the duty cycle of the PWM switch generator 18 such that the choke current I_s substantially corresponds to the neutral point input current I_np of the inverter 34 at the connection point Np.

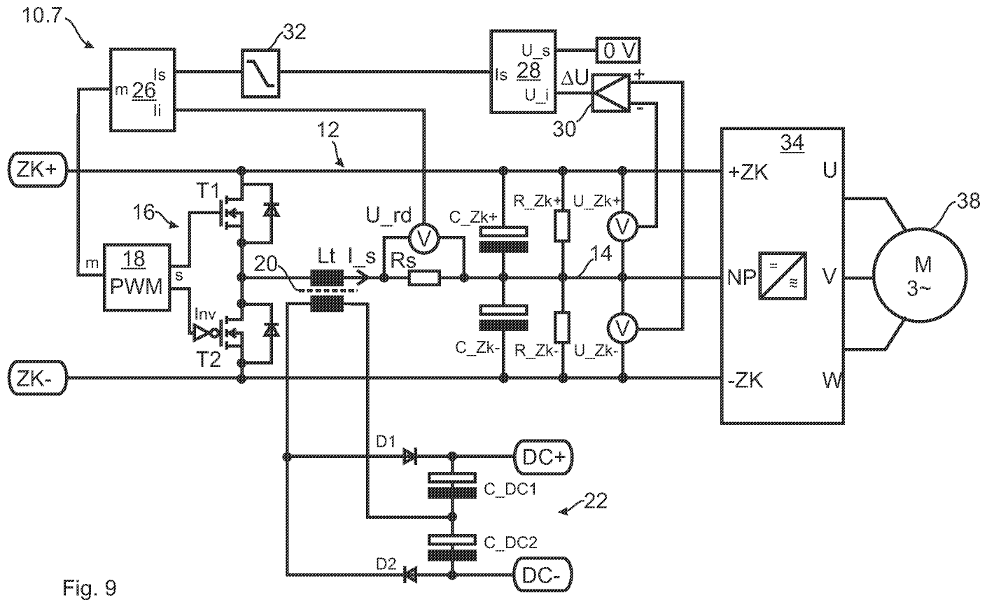

FIG. 9 shows a fifth embodiment of a device in accordance with the invention for intermediate circuit potential balancing 10.7, to operate a three-level inverter 34. This is substantially a combination of the design of the example according to FIG. 7 and the design of the example according to FIG. 8 with Greinacher voltage doubler. In FIG. 9, the voltage controller 28 and the current controller 26 are connected one behind the other as a cascade controller, wherein the current controller 26, which has the current through the smoothing choke Lt as its first input variable, can advantageously have a faster control behavior than the voltage controller 28. The second input variable of the current controller 26 is connected to the set value output of the voltage controller 28 via a current limiter 32, which can ensure that the current permissible for the components is not exceeded. With the aid of this cascade controller principle, a dependable neutral point can be inexpensively provided for a wide range of applications, allowing a high quality of the output voltage of the inverter 34 to be achieved.

### REFERENCE NUMERAL LIST

10 Device for intermediate circuit potential balancing

12 DC intermediate circuit

14 Intermediate potential rail

16 Half bridge

18 PWM switch generator with dead time generation

20 Isolating transformer

22 DC power pack

26 Current controller

28 Voltage controller

30 Differential amplifier

32 Current limiter

34 Three-level inverter

36 Rectifier

38 Three-phase consumer/three-phase grid/three-phase motor

40 DC converter

100 Inverter of the prior art

104 Filter

106 Three-phase producer/three-phase grid/three-phase generator

ZK+ Positive intermediate circuit potential

ZK− Negative intermediate circuit potential

Lt Smoothing choke

Rd, Rd1, Rd2 Damping resistor

Rs, Rs1, Rs2 Shunt resistor

T1 Electronic switch, power transistor

T2 Electronic switch, power transistor

R_ZK+ Voltage divider resistor +

R_ZK− Voltage divider resistor −

C_ZK+ Smoothing capacitor +

C_ZK− Smoothing capacitor −

Inv Inverter

D1-D22 Power pack diodes

C_DC Power pack capacitor

I_s Current through smoothing choke

I_np Neutral point input current in three-level inverter

ΔU Potential difference between intermediate potential and base potentials

NP Neutral point

U_ZK+ Voltmeter +

U_ZK− Voltmeter −

U_rd Damping resistor voltmeter

1. A device for balancing at least one intermediate potential of a DC intermediate circuit to operate a three-level or multilevel inverter, comprising:
a half bridge with at least two electronic switches connected between two base potential rails of the DC intermediate circuit and at least one intermediate potential rail; and
a PWM switch generator configured to operate the at least two switches in a variable duty cycle such that a desired intermediate potential of the intermediate potential rail is settable, wherein the half bridge is connected via a smoothing choke to the intermediate potential rail, and the smoothing choke forms a coil side of an isolating transformer for operating a DC power pack, which provides an internal voltage supply to the three-level or multi-level inverter.

2. The device according to claim 1, wherein the DC power pack comprises a DC converter with which a settable DC voltage at an output side of the DC power pack.

3. The device according to claim 1, wherein the DC power pack provides a voltage level in the range from 3.3 V to 48 V DC, wherein the isolating transformer comprises at least one secondary winding.

4. The device according to claim 1, wherein the DC power pack comprises a Greinacher voltage doubler circuit.

5. The device according to claim 1, wherein the PWM switch generator is configured to set a predefinable duty cycle of the two switches.

6. The device according to claim 1, wherein the smoothing choke is connected in series to a damping resistor.

7. The device according to claim 1, wherein two damping resistors are connected in the half bridge, wherein a connection point of the damping resistors is connected to the intermediate potential rail to the smoothing choke by the smoothing choke.

8. The device according to claim 1, further comprising a voltage controller which, on a basis of a voltage difference between the base potential rails and the intermediate potential rail, adjusts the duty cycle of at least one PWM signal of the PWM switch generator with regard to a desired intermediate potential.

9. The device according to claim 8, wherein the voltage controller and a current controller are connected one behind the other as a cascade controller, wherein the current controller has a faster control behavior than the voltage controller.

10. A method for operating a device to balance an intermediate potential of at least one intermediate potential rail of a DC intermediate circuit with two base potential rails to operate a three-level or multi-level inverter, wherein a desired intermediate potential is set by means of a half bridge with at least two electric switches which connects the intermediate potential rail to the base potential rails via a smoothing choke, by setting a variable duty cycle of the electric switches, wherein via the smoothing choke, designed as a coil side of an isolating transformer, a supply voltage for operating a DC power pack, is provided.

11. A method according to claim 10, wherein duty cycles are set symmetrically.

12. A method according to claim 10, wherein at least one duty cycle is set by means of voltage control by a voltage controller on the basis of a voltage difference between the intermediate potential and the two base potentials.

13. A method according to claim 10, wherein at least one duty cycle is set by means of current control by a current controller on a basis of a current through a smoothing choke connecting the half bridge to the intermediate potential rail.

14. A method according to claim 12, wherein setting of at least one duty cycle is achieved by a cascade control of the voltage control and current control, wherein current control has a faster control behavior than voltage control.
